(19) United States
(12) Patent Application Publication
(10) Pub. No.: US 2026/0245031 A1
(43) Pub. Date: Aug. 20, 2026

(54) SYSTEM AND METHOD FOR SECURE ITEM EXCHANGE USING LOCAL PICKUP AND DELIVERY SERVICES

(71) Applicant: SHOPXCHANGE, Fort Smith, AR (US)

(72) Inventors: Wanda Vaughn, Fort Smith, AR (US); Jake Vaughn, Fort Smith, AR (US); Stone Vaughn, Fort Smith, AR (US); Reid Vaughn, Fort Smith, AR (US)

(21) Appl. No.: 19/543,776

(22) Filed: Feb. 18, 2026

Related U.S. Application Data
(60) Provisional application No. 63/759,664, filed on Feb. 18, 2025.

(51) Int. Cl. G06Q 10/0836

(52) U.S. Cl. CPC G06Q 10/0836

(57) ABSTRACT

System and method for secure item exchange using local pickup and delivery services are disclosed. The method includes enabling users to list items for sale and browse items available for purchase and facilitating transactions between buyers and sellers such that personal information of the users is not disclosed during the transaction. Next, the method includes generating and managing unique drop-off and pickup identification numbers for facilitating the exchange of items at a designated local site. Next, the method includes confirming the item at the local site by displaying image/description of the item based on the identification number. Next, the method includes sending real-time notifications to the buyer and seller regarding the status of the transaction and the availability of the item for pickup or drop-off. Thereafter, the method includes integrating with third-party delivery services to offer home delivery as an optional service, upon buyer request, at an additional cost.

### BACKGROUND OF THE INVENTION

The present application claims the benefit of U.S. Provisional Application No. 63/759,664, filed Feb. 18, 2025; all of which is incorporated herein and referenced thereto.

### FIELD OF THE INVENTION

The present invention relates to item exchange systems, and particularly relates to system and method for secure item exchange using local pickup sites and delivery services to ensure privacy, confidentiality, and secure transactions without the need for in-person meetings or sharing personal information.

### DESCRIPTION OF THE PRIOR ART

Item exchange systems facilitate the buying, selling, and trading of goods between individuals or businesses. These systems are essential in both e-commerce and traditional marketplaces, allowing users to connect and exchange items based on mutual agreements. In today's digital age, online item exchange platforms have become increasingly popular, providing a convenient way for users to buy and sell products from various locations.

Current item exchange solutions often include online marketplaces, classified ads, and reselling platforms. For instance, a US patent application US 2016/0125513 A1 discloses a downloadable application that allows users to view, sort, and sell goods while keeping personal information anonymous. Similarly, a U.S. Pat. No. 11,100,547 B2 discloses a private marketplace that facilitates anonymous or selectively disclosed interactions, maintaining confidentiality throughout the transaction. Another system, disclosed in WIPO patent application WO 00/43933A9, focuses on local commerce by enabling users to search for items within a set geographical radius. These platforms provide ease of access, product visibility, and the convenience of finding items within local or global communities.

However, despite the advantages of current solutions, they come with significant challenges, particularly concerning privacy and security. Many platforms, such as the one disclosed in a US patent application US 2016/0125513 A1, still require users to meet in person to exchange items, which raises safety concerns. This face-to-face interaction can lead to uncomfortable or potentially risky situations. Additionally, a U.S. Pat. No. 11/288,722 B2, while focusing on anonymized online shopping systems, still leaves room for improvement in ensuring the physical security of the exchange process. Furthermore, sharing personal contact information for meetups or deliveries compromises user privacy.

Moreover, current platforms lack robust mechanisms to guarantee secure transactions. Issues like disputes over item quality, incomplete deliveries, and the absence of standardized verification methods often lead to user dissatisfaction. These gaps highlight the need for a more advanced system that ensures privacy, protects personal information, and secures item exchanges without requiring in-person meetings or direct interaction between buyers and sellers.

Therefore, there is a need for a system and method for secure item exchange using local pickup and delivery services to overcome the drawbacks of the prior arts.

The information disclosed in this background of the disclosure section is only for enhancement of understanding of the general background of the disclosure and should not be taken as an acknowledgment or any form of suggestion that this information forms existing information already known to a person skilled in the art.

### SUMMARY OF THE INVENTION

An object of the present disclosure is to provide a system and method (together termed as “mechanism”) for secure item exchange using local pickup and delivery services. The mechanism is designed to streamline the buying and selling of items without requiring direct interactions or the exchange of personal information between buyers and sellers. The mechanism operates as an integrated e-commerce platform that facilitates transactions through local pickup sites, ensuring that both privacy and confidentiality are maintained throughout the process.

In operation, when a transaction is initiated, the seller receives a confirmation notification containing a unique drop-off number, which the seller uses to drop off the sold item at a designated local business or pickup site. At the time of drop off, the pickup site user verifies the item using a system-based image, enters the drop-off number, and stores the item securely until the buyer arrives. Once the item is confirmed as dropped off, the mechanism generates a pickup number, which is sent to the buyer. The buyer can then visit the local pickup site and present the pickup number to receive the item. At the pickup point, the site user cross-verifies the item using the mechanism to ensure that the dropped off item matches the correct purchase, enters in the pick-up number, thus facilitating a secure exchange without any personal interaction between the buyer and seller.

In an embodiment, the disclosure also offers additional services, including the option for buyers to have items delivered to their homes through third-party services like Uber™ or DoorDash™. Such third-party services provide flexibility for buyers who may prefer not to visit the local pickup site in person, thus offering a seamless delivery experience. Also, the mechanism uses encrypted communication, unique identifiers, and a verification process involving images of the item to prevent fraud or miscommunication. Since the existing solutions that enable local exchanges or online transactions, often fall short in ensuring privacy, secure handling, and optional delivery services, the disclosed mechanism creates a trusted and efficient system for item exchanges, protecting user confidentiality and offering more secure, flexible transaction options compared to current marketplace platforms.

An embodiment of the present disclosure discloses the system for secure item exchange using local pickup and delivery services. The system includes a marketplace module to enable users to list items for sale and browse items available for purchase. The marketplace module further automatically removes sold items from the marketplace to prevent the listing of unavailable items. The system also includes a transaction management module to facilitate transactions between buyers and sellers, wherein personal information of the users is not disclosed during the transaction. Such transaction management module anonymizes communication between the buyer and seller through the marketplace platform during the transaction. Also, the transaction management module enables dispute resolution through the marketplace platform in case of disagreements over the transaction or item condition.

Further, the system also includes a pickup coordination module to generate and manage unique drop-off and pickup identification numbers for facilitating the exchange of items at a designated local site. Such pickup coordination module also allows users to select a preferred local pickup site from a list of available locations based on geographical proximity. Furthermore, the system includes a verification module to confirm the identity of the item at the local site by displaying an image or description of the item based on the identification number provided by the buyer or seller. Such verification module also uses image recognition software over the exact image that the seller used when posting the item to verify the authenticity of the item being exchanged at the pickup site. Further, once the pick-up number is entered, the verification module generates a digital record of the pickup process, including a timestamp and photographic evidence of the exchanged item, to ensure transaction transparency.

Furthermore, the system includes a notification module to send real-time notifications to the buyer and seller regarding the status of the transaction and the availability of the item for pickup or drop-off. Such notification module also sends reminders to both the buyer and seller about deadlines for pickup or drop-off, ensuring timely completion of the transaction. Additionally, the system includes a delivery coordination module to integrate with third-party delivery services to offer home delivery as an optional service, upon buyer request, at an additional cost. Such delivery coordination module integrates with at least one third-party service selected from the group consisting of Uber™, DoorDash™, and similar delivery services.

An embodiment of the present disclosure discloses the method for secure item exchange using local pickup and delivery services. The method includes the steps of enabling users to list items for sale and browse items available for purchase. Additionally, the method includes automatically removing sold items from the marketplace to prevent the listing of unavailable items. Next, the method includes the steps of facilitating transactions between buyers and sellers, wherein personal information of the users is not disclosed during the transaction. The method anonymizes communication between the buyer and seller through the marketplace platform during the transaction. Also, the method includes the steps of enabling dispute resolution through the marketplace platform in case of disagreements over the transaction or item condition.

Next, the method includes the steps of generating and managing unique drop-off and pickup identification numbers for facilitating the exchange of items at a designated local site. The method also allows users to select a preferred local pickup site from a list of available locations based on geographical proximity. Next, the method includes the steps of confirming the identity of the item at the local site by displaying an image or description of the item based on the identification number provided by the buyer or seller. The method also uses image recognition software over the exact image that the seller used when posting the item to verify the authenticity of the item being exchanged at the pickup site. Next, the method includes the steps of generating a digital record of the pickup process, including a timestamp and photographic evidence of the exchanged item, to ensure transaction transparency.

Next, the method includes the steps of sending real-time notifications to the buyer and seller regarding the status of the transaction and the availability of the item for pickup or drop-off. The method also includes sending reminders to both the buyer and seller about deadlines for pickup or drop-off, ensuring timely completion of the transaction. Thereafter, the method includes the steps of integrating with third-party delivery services to offer home delivery as an optional service, upon buyer request, at an additional cost. Such integration is performed with at least one third-party service selected from the group consisting of Uber™, DoorDash™, and similar delivery services.

These and other objects of the present invention will be apparent from review of the following specification and the accompanying drawings.

### BRIEF DESCRIPTION OF THE DRAWINGS

FIG. 1 is an exemplary environment of a system for secure item exchange using local pickup and delivery services, in accordance with an embodiment of the present disclosure.

FIG. 2 is the system for secure item exchange using local pickup and delivery services, in accordance with an embodiment of the present disclosure.

FIGS. 3A-3D are various user interfaces of a seller's user device during selling of the item, in accordance with an embodiment of the present disclosure.

FIGS. 4A-4D are various user interfaces of a facilitator's (or exchange site) user device during facilitating the exchange of the item, in accordance with an embodiment of the present disclosure.

FIGS. 5A-5E are various user interfaces of a buyer's user device during buying of the item, in accordance with an embodiment of the present disclosure.

FIG. 6 is a flowchart illustrating a method for secure item exchange using local pickup and delivery services, in accordance with an embodiment of the present disclosure.

FIG. 7 is an exemplary computer unit in which or with which embodiments of the present disclosure may be utilized.

### DETAILED DESCRIPTION OF THE PREFERRED EMBODIMENT

The detailed description set forth below in connection with the appended drawings is intended as a description of exemplary embodiments in which the presently disclosed disclosure can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed disclosure. However, it will be apparent to those skilled in the art that the presently disclosed disclosure may be practiced without these specific details. In some instances, well-known structures and devices are shown in block diagram form in order to avoid obscuring the concepts of the presently disclosed disclosure.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and/or firmware.

Embodiments of the present disclosure may be provided as a computer program product, which may include a non-transitory, machine-readable storage medium tangibly embodying thereon instructions, which may be used to program the computer (or other electronic devices) to perform a process. The machine-readable medium may include, but is not limited to, fixed (hard) drives, semiconductor memories, such as Read Only Memories (ROMs), Programmable Read-Only Memories (PROMs), Random Access Memories (RAMs), Erasable PROMs (EPROMs), Electrically Erasable PROMs (EEPROMs), flash memory or other types of media/machine-readable medium suitable for storing electronic instructions (e.g., computer programming code, such as software or firmware.

Various methods described herein may be practiced by combining one or more non-transitory, machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection. Based on the disclosure provided herein, one of ordinary skill in the art will appreciate a variety of ways in which connection or coupling exists in accordance with the definition.

Further, the term “module” may be software or hardware particularly programmed to receive an input, perform one or more processes using the input, and provide an output. The input, output, and processes performed by various modules will be apparent to one skilled in the art based on the present disclosure.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

Embodiments of the present disclosure relate to a system and method (together termed as “mechanism”) for secure item exchange using local pickup and delivery services. The mechanism may be designed to streamline the buying and selling of items without requiring direct interactions or the exchange of personal information between buyers and sellers. The mechanism may operate as an integrated e-commerce platform that facilitates transactions through local pickup sites, ensuring that both privacy and confidentiality are maintained throughout the process.

In operation, when a transaction is initiated, the seller may receive a confirmation notification containing a unique drop-off number, which the seller may use to drop off the sold item at a designated local business or pickup site. At the time of drop off, the pickup site user may verify the item using a system-based image and store it securely until the buyer arrives. Once the item is confirmed as dropped off, the mechanism may generate a pickup number, which may be sent to the buyer. The buyer may then visit the local pickup site and present the pickup number to receive the item. At the pickup point, the site user may cross-verify the item using the mechanism to ensure that it matches the correct purchase, thus facilitating a secure exchange without any personal interaction between the buyer and seller.

In an embodiment, the mechanism may also offer additional services, including the option for buyers to have items delivered to their homes through third-party services like Uber™ or DoorDash™. Such third-party services may provide flexibility for buyers who may prefer not to visit the local pickup site in person, thus offering a seamless delivery experience. Also, the mechanism may use encrypted communication, unique identifiers, and a verification process involving images of the item to prevent fraud or miscommunication. Since the existing solutions that enable local exchanges or online transactions, often fall short in ensuring privacy, secure handling, and optional delivery services, the disclosed mechanism creates a trusted and efficient system for item exchanges, protecting user confidentiality and offering more secure, flexible transaction options compared to current marketplace platforms.

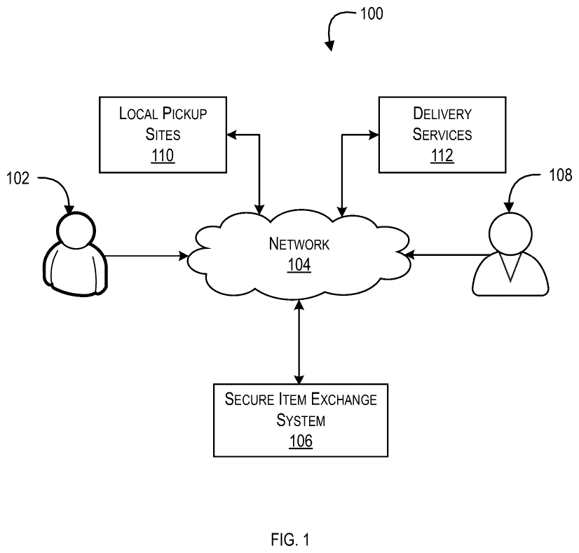

FIG. 1 is an exemplary environment 100 of a system 106 for secure item exchange using local pickup 110 and delivery services 112, in accordance with an embodiment of the present disclosure. In an embodiment, the exemplary environment 100 may include a seller 102, a buyer 108, a network 104, local pickup sites 110, delivery services 112, and a secure item exchange system 106 (hereinafter termed as system 106). In an embodiment, the system 106 may be implemented on a server that may, without any limitation, include a cloud server. The interconnected environment 100 may enable seamless and secure transactions while ensuring privacy and confidentiality for both the buyer 108 and the seller 102. In general, the system 106 may facilitate communication between the buyer 108, seller 102, local pickup sites 110, and optional delivery services 112 by processing orders, generating secure identifiers (such as drop-off and pickup numbers), and maintaining the status of each transaction, ensuring that every exchange is tracked and verified. In an embodiment, all communication and data transfer within the environment 100 may occur over a secure network 104 that may connect the system 106 to the buyer 108, seller 102, local pickup site 110, and delivery services 112. The network 104 may ensure that all interactions, such as transmitting identifiers, updating transaction statuses, and verifying exchanges, are handled in a secure and reliable manner. Additionally, data privacy may be maintained throughout, with the system 106 anonymizing user information and preventing unauthorized access to sensitive data.

In an embodiment, the communication network 104 may include, without limitation, a direct interconnection, a Local Area Network (LAN), a Wide Area Network (WAN), a wireless network (e.g., using Wireless Application Protocol), the Internet, and the like.

For the purpose of the disclosure, the seller 102 may correspond to a user that interacts with the system 106 by listing items for sale and dropping them off at designated local pickup sites 110 when a drop number is issued. Further, the drop number may be issued to the seller when a buyer purchases their item posted. Further, buyers may keep their inventory and not provide it to the marketplace until they are issued the drop number and the exchange site or marketplace may only hold items in which the drop number has been issued and item dropped off by the seller after receiving a confirmation and drop-off number. Similarly, the buyer 108 may correspond to a user that purchases items through the system 106 and is provided with a pickup number once the seller 102 has dropped off the item, enabling them to retrieve it from the local pickup site. The local pickup site 110 may act as secure exchange points where items are verified, stored, and handed over to the buyer upon presentation of the pickup number. Further, the delivery services 112 may be engaged by the buyer 108 for home delivery, offering flexibility in item retrieval.

In operation, the seller 102 may interact with the system 106 by listing an item for sale. Once a buyer 108 places an order, the system 106 may notify the seller 102 of the confirmed sale and issue a unique drop-off number. The seller 102 may then use the issued drop-off number when delivering the item to the designated local pickup site 110. The system 106 may maintain anonymity of the seller and ensure that no personal information is exchanged between the seller and buyer. It may be apparent to a person skilled in the art that the local pickup site 110 may play a crucial role in the transaction, acting as an intermediary location where the physical exchange of goods occurs. After the seller 102 drops off the item, the pickup site 110 may verify the item using information provided by the system 106, such as item details and images. The item may then be stored securely at the site until the buyer 108 arrives. Once the pickup site 110 confirms the drop-off, the system 106 may generate a pickup number for the buyer 108.

When the buyer 108 receives the pickup number, the buyer 108 may visit the local pickup site 110 to retrieve the item. Upon arrival, the buyer 108 may present the pickup number, and the site staff may use the system 106 to verify the correct item and confirm the exchange. In an embodiment, the buyer 108 may have an option to inspect the item before acceptance, ensuring a secure and satisfactory transaction. In an embodiment, the environment 100 may also support the third-party delivery services 112, which may be engaged in case the buyer 108 opts for home delivery instead of picking up the item in person. The system 106 may coordinate with the third-party delivery services 112 to arrange for secure transportation of the item from the local pickup site 110 to the buyer. In such a scenario, the delivery service 112 may interact with the system 106 to ensure that the item is correctly identified and delivered.

In an embodiment, the seller 102 and the buyer 108 may use respective associated user devices, such as smartphones, tablets, or computers, to access the system 106. The user devices may enable both parties (the seller 102 and the buyer 108) to interact with the system 106 for managing transactions, tracking item exchanges, and receiving secure communications related to the exchange process.

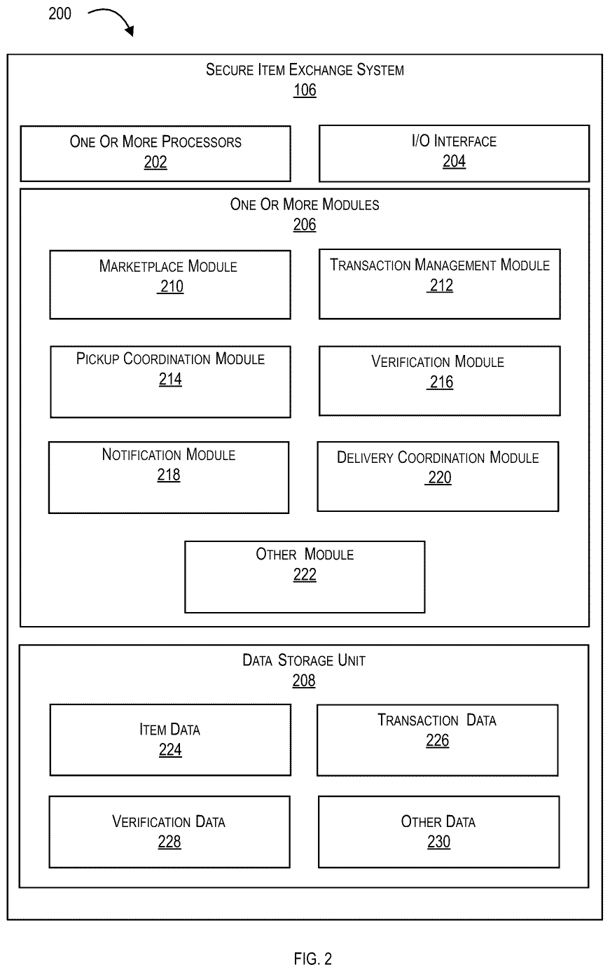

FIG. 2 is the system 106 for secure item exchange using local pickup 110 and delivery services 112, in accordance with an embodiment of the present disclosure. In an embodiment, the system 106 may include one or more processors 202, an Input/Output (I/O) interface 204, one or more modules 206, and a data storage unit 208. The one or more processors 202 may be implemented as one or more microprocessors microcomputers, microcomputers, digital signal processors, central processing units, state machines, logic circuitries, and/or any devices that manipulate signals based on operational instructions. Further, the I/O interface 204 may serve as the pivotal bridge connecting the internal processes of the system 106 with its external environment for facilitating the exchange of information between the system 106 and its users or external devices. Furthermore, the I/O interface 204 may contribute to the user experience by providing intuitive means for input, such as through keyboards or touchscreens, and presenting meaningful output via displays or other output devices. In an embodiment, the one or more modules 206 may include a marketplace module 210, a transaction management module 212, a pickup coordination module 214, a verification module 216, a notification module 218, a delivery coordination module 220, and any other module 222 essential or required for the working of the system 106. In an embodiment, the data storage unit 208 may include item data 224, transaction data 226, verification data 228, and any other data 230 required for the working of the system 106. In an embodiment of the present disclosure, the one or more processors 202 and the data storage unit 208 may form a part of a chipset installed in the system 106. In another embodiment of the present disclosure, the data storage unit 208 may be implemented as a static memory or a dynamic memory. In an example, the data storage unit 208 may be internal to the system 106, such as an onside-based storage. In another example, the data storage unit 208 may be external to the system 106, such as cloud-based storage. Further, the one or more module 206 may be communicatively coupled to the data storage unit 208 and the one or more processor 202 of the system 106. The one or more processors 202 may be configured to control the operations of the one or more modules 206.

In an embodiment, the marketplace module 210 may enable users to list items for sale and browse items available for purchase. Additionally, the marketplace module 210 may automatically remove sold items from the marketplace to prevent the listing of unavailable items. Accordingly, the marketplace module 210 may facilitate secure item exchanges between users without the need for in-person meetings or sharing personal information. The marketplace module 210 may facilitate the seller 102 to interact with the marketplace by uploading item descriptions, prices, and images to create detailed listings for potential buyers. The created detailed listing may be stored and managed as the item data 224, ensuring that the buyers 108 receive accurate and up-to-date details about available products. When the buyer 108 places an order, the marketplace may process the transaction and generate the unique drop-off number for the seller 102, which is part of the transaction data 226. Such drop-off number may be used by the seller 102 to drop-off the item at the designated local pickup site 110. In turn, the marketplace module may generate the pickup number for the buyer 108, ensuring a seamless, traceable transaction.

In an embodiment, the transaction management module 212 may facilitate transactions between buyers 108 and sellers 102 in a way that personal information of the users is not disclosed during the transaction by anonymizing communication between the buyer 108 and seller 102 through the marketplace platform during the transaction. Further, the transaction management module 212 may enable dispute resolution through the marketplace platform in case of disagreements over the transaction or item condition. Furthermore, the transaction management module 212 may oversee and coordinate the entire transaction process between the buyers 108, sellers 102, and local pickup sites 110 by managing the creation and distribution of unique identification numbers, such as drop-off numbers for sellers and pickup numbers for buyers, ensuring secure and trackable exchanges. In an embodiment, the transaction management module 212 may handle all transaction data 226, including payment processing, and ensures that each step, from item drop-off to item pick-up, is verified and updated in real-time. Further, the transaction management module 212 may utilize the verification data 228 to confirm item authenticity and resolve disputes, ensuring a seamless and secure exchange process.

In an embodiment, the pickup coordination module 214 may generate and manage unique drop-off and pickup identification numbers for facilitating the exchange of items at the designated local site. The pickup coordination module 214 may also allow users to select a preferred local pickup site from a list of available locations based on geographical proximity. Accordingly, the pickup coordination module 214 may manage the logistics of item exchanges at local pickup site 110, ensuring a smooth and secure handover between sellers 102, buyers 108, and local pickup site 110. The pickup coordination module 214 may track the use of drop-off numbers provided to the sellers 102 during item drop-off at the designated site, and subsequently generate pickup numbers for buyers to pick-up the items. Additionally, the pickup coordination module 214 may facilitate real-time communication with the local site 110, ensuring the item is ready for pickup and that both parties are informed throughout the process.

In an embodiment, the verification module 216 may confirm the identity of the item at the local pickup site 110 by displaying image or description of the item based on the identification number provided by the buyer 108 and/or seller 102. In one scenario, the verification module 216 may use image recognition software to verify the authenticity of the item being exchanged at the pickup site. Further, the verification module 216 may generate a digital record of the pickup process, including a timestamp and photographic evidence of the exchanged item, to ensure transaction transparency. Furthermore, the verification module 216 may handle the authentication of items during both drop-off and pickup at the local site 110. In one instance, when the seller 102 drops off an item, the verification module 216 may record the verification data 228, such as images or other identifying information about the item which may be stored and later used to ensure that buyer 108 receives the correct item. In another instance, at the pickup stage, the verification module 216 may compare the stored data with the item being collected, allowing the buyer 108 and the local site 110 to confirm the item authenticity before completing the transaction.

In an embodiment, the notification module 218 may send real-time notifications to the buyer 108 and seller 102 regarding the status of the transaction and the availability of the item for pickup or drop-off. Further, the notification module 218 may also send reminders to both the buyer 108 and seller 102 about deadlines for pickup or drop-off, ensuring timely completion of the transaction. Furthermore, the notification module 218 may send timely alerts to the seller 102, buyer 108, and local pickup site 110 at key stages of the transaction. For example, when the buyer 108 places an order, the notification module 218 may send a confirmation to the seller 102, providing the drop-off number for the item. Once the seller 102 drops off the item, the notification module 218 may notify the buyer 108, supplying the pickup number required to collect the item.

In an embodiment, the delivery coordination module 220 may integrate with third-party delivery services 112 to offer home delivery as an optional service, upon buyer 110 request, at an additional cost. The delivery coordination module 220 may integrate with at least one third-party service selected from the group consisting of Uber™, DoorDash™, and similar delivery services. Accordingly, the delivery coordination module 220 may manage the logistics of item transportation when the buyers 108 opt for delivery instead of local pickup and may ensure that once the item is dropped off by the seller 102, the delivery service 112 is notified, and the necessary details for pickup and delivery are arranged.

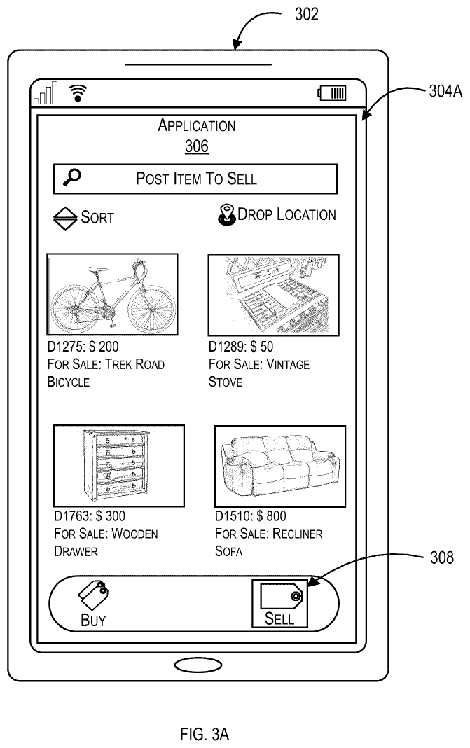

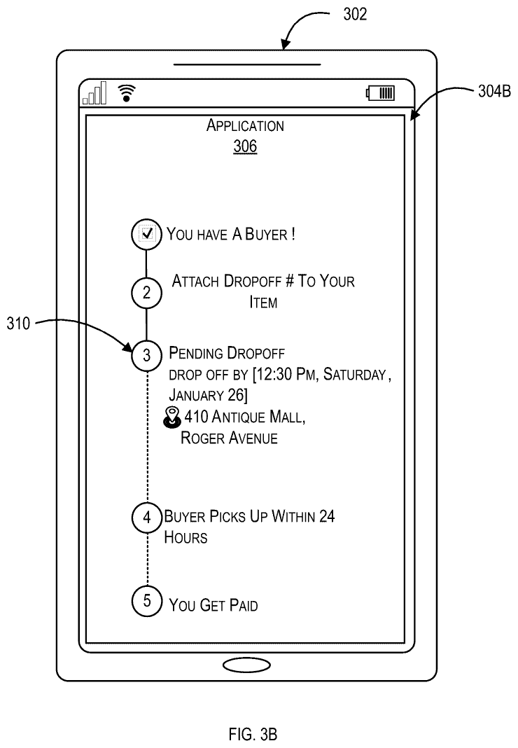

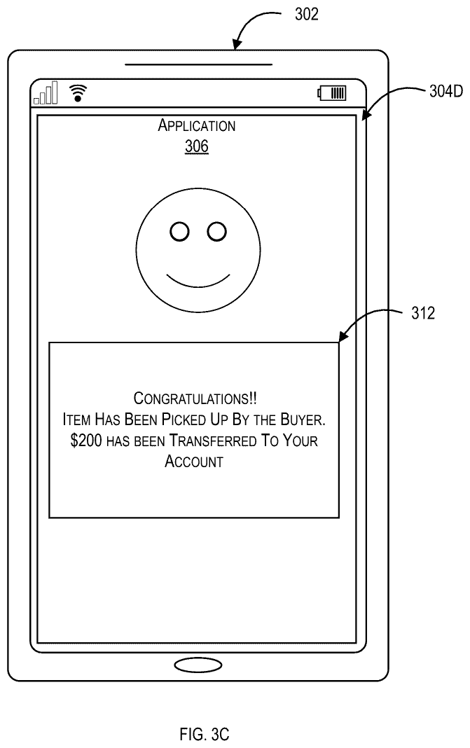

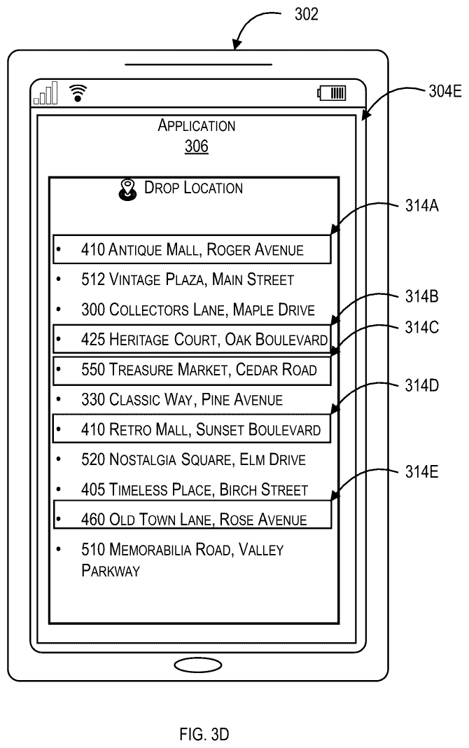

FIGS. 3A-3D are various user interfaces 304A, 304B, 304C, and 304D of the seller 102 user device 302 during the selling of the item, in accordance with an embodiment of the present disclosure. In an embodiment, as shown in FIG. 3A, the seller 102 may log into the application 306 and may list items to sell. Additionally, or alternatively, the seller 102 may upload a new item by adding new item data such as an image or description without departing from the scope of the present disclosure. Once the item is posted to sell, the seller 102 can select which drop off locations from the options available to deliver the item when sold. Further, the seller 102 can choose one up to all locations available and if more than one site is selected, the buyer has the choice of selecting which site to pick-up the item from. It may be apparent to a person skilled in the art that the drop off location may correspond to the local pickup site 110. Once the item is posted and the drop off location is finalized, the seller 102 may click on an option to sell 308 for listing the item in the marketplace for the buyers to view. When the seller 102 has a buyer 108, the seller 102 may be notified, as shown in FIG. 3B. A drop off identification number will be provided to the seller with instructions to attach the identification number to the sold item.

In an embodiment, the seller 102 may be provided a timeframe to drop off the item at the selected drop off location, as shown by 310. In an embodiment, as shown in FIG. 3C, once the buyer 108 picks up the item from the drop off site, the seller 102 may receive, without any limitation, a notification 312 informing about the picking up of the item and the transfer of funds to the seller 102 account.

In an additional embodiment, as shown in FIG. 3D, the seller 102, prior to the posting the item for sale, can select one or more locations from a plurality of available drop-off locations to deliver the item when sold. For example, the FIG. 3D shows multiple locations out of which 314A, 314B, 314C, and 314D are selected by the seller 102.

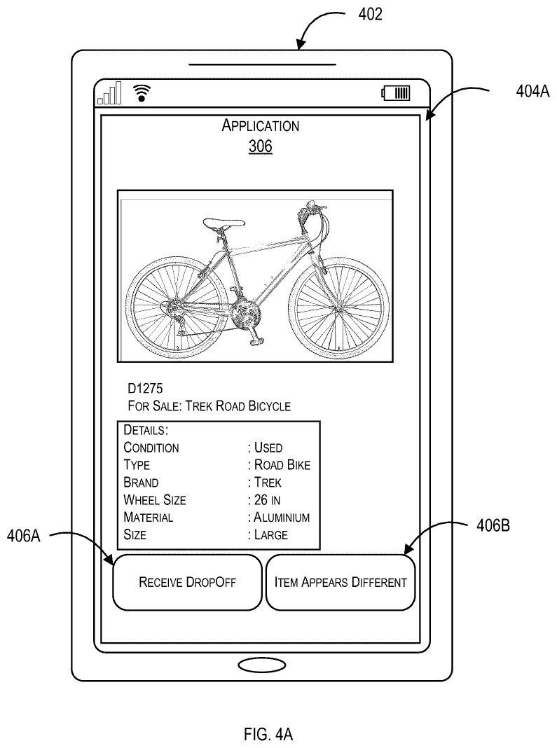

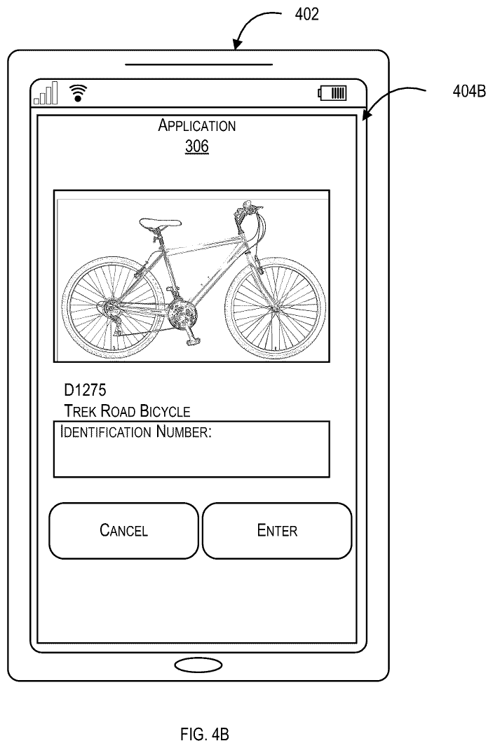

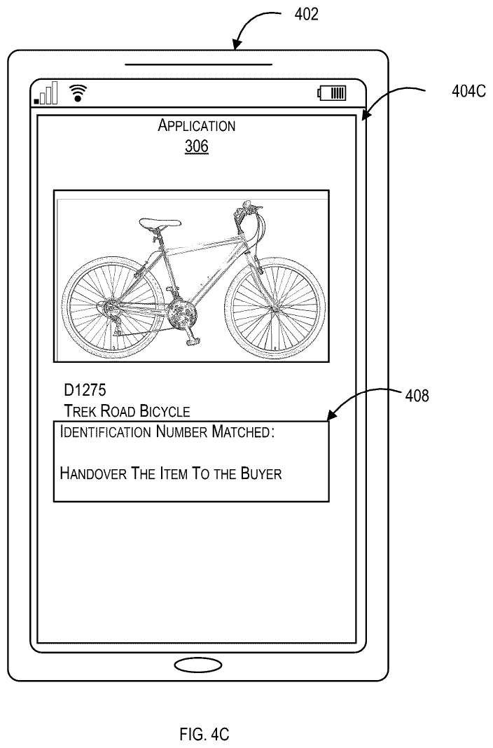

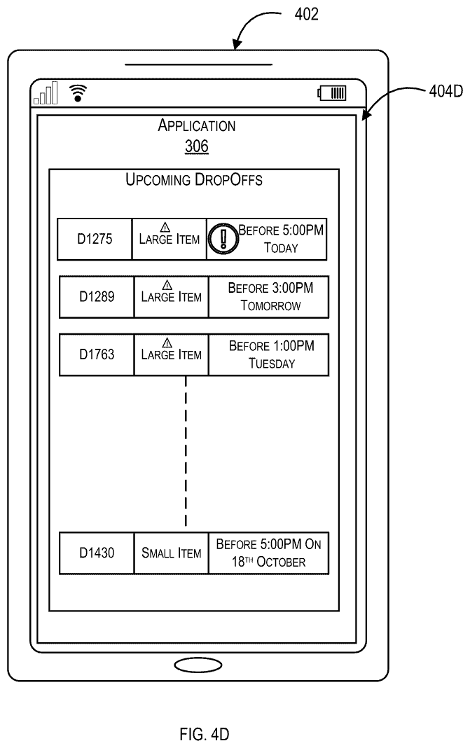

FIGS. 4A-4C are various user interfaces 404A, 404B, 404C, and 404D of a facilitator (or exchange site) user device 402 during facilitating the exchange of the item, in accordance with an embodiment of the present disclosure. In an embodiment, as shown in FIG. 4A, the facilitator (such as a user at the drop off location), upon receiving the item from the seller 102, may log into the application 306 and store the item in the inventory of the marketplace. Such storing into the inventory may be performed by selecting an option to receive drop off 406A, however, if the item listed by the seller 102 does not match the item received in the drop off 406B i.e., does not match the image in the application, then the facilitator may decline entering the drop-off number into the application. In a scenario, when the items appear different, the item may not be stored in the inventory, and the exchange/selling of the item may be canceled. In an embodiment, as shown in FIG. 4B, when the buyer 108 arrives to receive the item, the buyer may provide the facilitator a pick up number which the facilitator may enter into the application 306. The application 306 may facilitate identifying the item associated with the pick up number provided by the buyer. In one case, if the numbers does not exist, the application 306 may provide a notification “listing not found”. In another case, if the numbers match, the facilitator may select the option ‘enter’ to allow the selling of the item from the inventory of the marketplace to the buyer 108. In an embodiment, as shown in FIG. 4C, when the numbers match then the facilitator will tap the facilitate pick up button, thus sending a notification 408 to the seller 102 informing the seller 102 that the buyer 108 is verified and the item is handed over to the buyer 108.

In an embodiment, each item on the list may be accompanied by a detailed description, including information such as type of item, quantity, and any special handling requirements. Additionally, the facilitator's application 306 may provide the corresponding timeframes for each scheduled event, as shown in FIG. 4D allowing the facilitator to see when each item is expected to be dropped off or picked up.

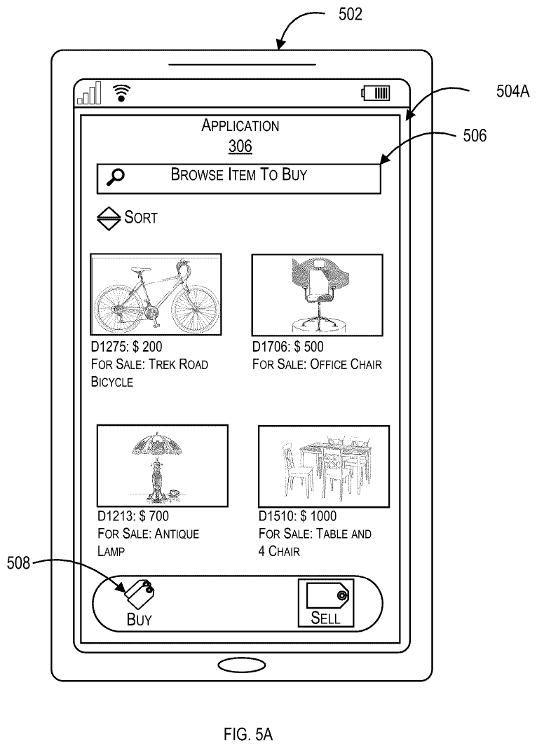

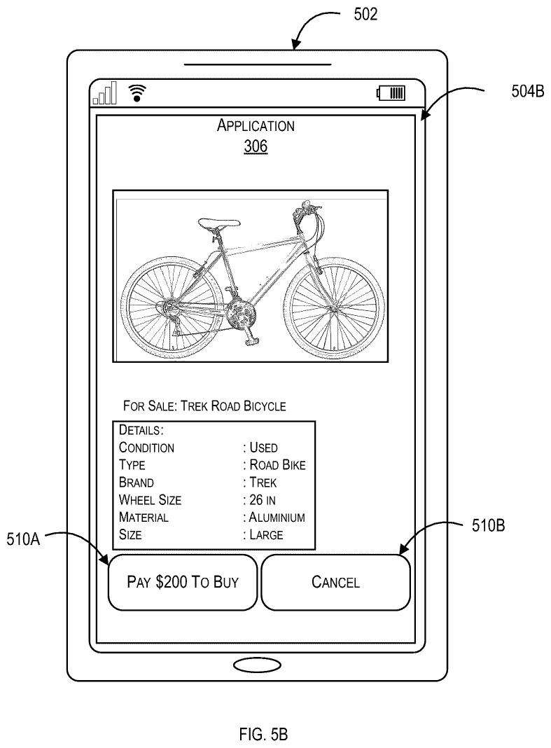

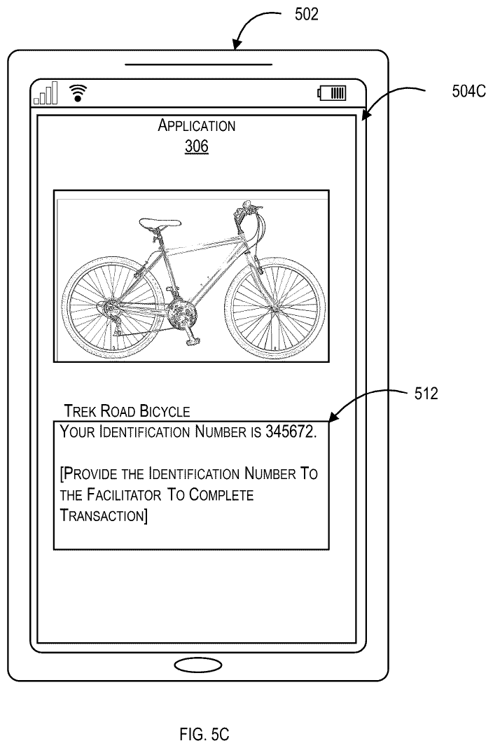

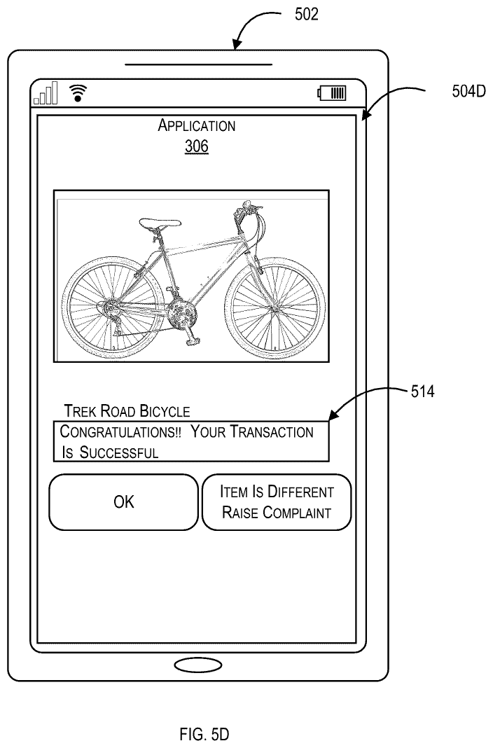

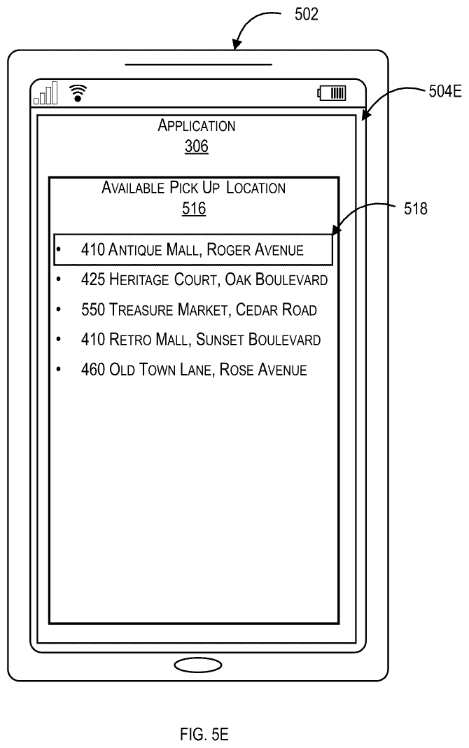

FIGS. 5A-5E are various user interfaces 504A-504E of the buyer 108 user device 502 during buying of the item, in accordance with an embodiment of the present disclosure. In an embodiment, as shown in FIG. 5A, the buyer 108 may log into the application 306 and may browse items to buy from the inventory, as shown by 506. Additionally, or alternatively, the buyer 108 may input data for a relevant item such as an image, description, price, or the like, without departing from the scope of the present disclosure. Once the item to buy is selected, the buyer 108 may then select an option to buy 508 the selected item in the marketplace. Before selecting the pick-up location, the buyer 108, as shown in FIG. 5B, may check the description of the item as entered by the seller. In one case, if the buyer 108 is satisfied with the description of the item, then the buyer 108 may select an option 510A to buy now and pay the corresponding price via the application 306 to buy the item. In another case, if the buyer 108 is not satisfied with the description of the item, then the buyer 108 may select an option 510B to cancel the buying/exchange of the item and exit the application 306. In an embodiment, as shown in FIG. 5C, the buyer 108 may be requested to provide the identification number, as shown by 512, to the facilitator to verify the buyer 108. In an embodiment, as shown in FIG. 5D, once the buyer 108 makes the payment, the buyer 108 may receive a notification 514 about the success of the transaction. In an embodiment, when the buyer selects to buy item, money is held into account and not transferred to the seller, until the item is accepted by the buyer at the exchange site (marketplace).

In an embodiment, the exchange site or facilitator may enter the buyers pick-up number into the application 306 for verification. The verification may facilitate acceptance of purchase, and completion of money transfer to the seller 102 is then completed. Thereafter, once the buyer 108 reaches the pick-up location, in one case, if the pick-up number that is entered into the application is verified, and the buyer confirms the number to be correct to the facilitator, the facilitator will process the transaction, which approves the transaction to transfer funds to the seller and complete the selling/exchange of the item. In another case, if the item does not match as described by the seller, then the buyer 108 may select to decline the pick up. The facilitator or exchange site may report that the items are different and raise a complaint, such that the transaction between buyer 108 and seller may be canceled. In an additional embodiment, as shown in FIG. 5E, the seller 102 may have selected one or more locations, as shown by 314A, 314B, 314C, 314D, and 314E in FIG. 3D. Accordingly, such one or more locations may be displayed to the buyer 108 as one or more available pick-up locations 516 and the buyer 108 may select a location 518 from the one or more locations from which the buyer 108 wants to pick up the item. In one case if the buyer fails to pick up purchased item, the buyer will still be charged and notification of failed pick-up will be sent to the seller with notification to retrieve the item.

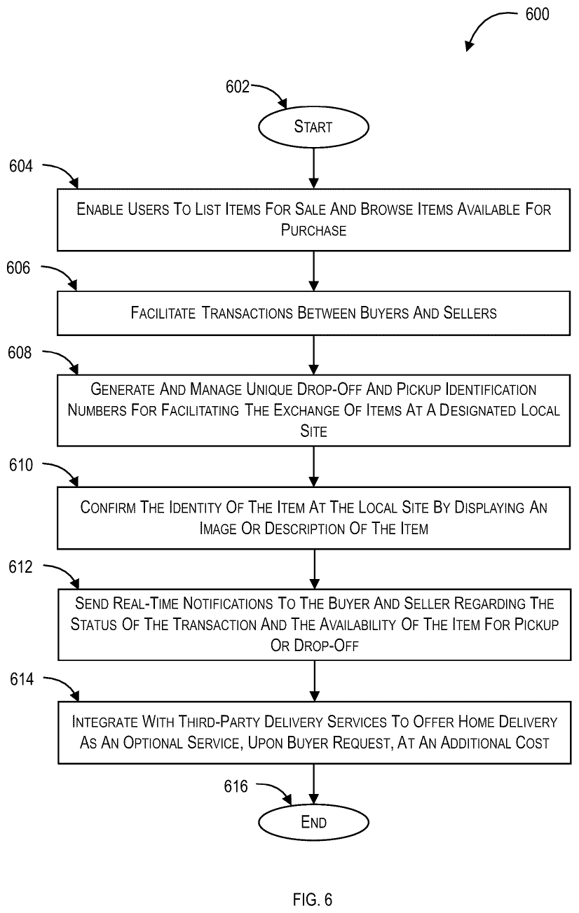

FIG. 6 is a flowchart 600 illustrating a method for secure item exchange using local pickup and delivery services, in accordance with an embodiment of the present disclosure. The method may start at step 602.

At first the method may include the steps of enabling users to list items for sale and browse items available for purchase, at step 604. The method may include the steps of automatically removing sold items from the marketplace to prevent the listing of unavailable items.

Next, at step 606, the method may include the steps of facilitating transactions between buyers and sellers, wherein personal information of the users is not disclosed during the transaction. Further, the method may anonymize communication between the buyer and seller through the marketplace platform during the transaction. Also, the method may include the steps of enabling dispute resolution through the marketplace platform in case of disagreements over the transaction or item condition.

Next, at step 608, the method may include the steps of generating and managing unique drop-off and pickup identification numbers for facilitating the exchange of items at a designated local site. The method may also include the steps of allowing users to select a preferred local pickup site from a list of available locations based on geographical proximity.

Next, at step 610, the method may include the steps of confirming the identity of the item at the local site by displaying an image or description of the item based on the identification number provided by the buyer or seller. The method may also use image recognition software over the exact image that the seller used when posting the item to verify the authenticity of the item being exchanged at the pickup site. Further, the method may also include the steps of generating a digital record of the pickup process, including a timestamp and photographic evidence of the exchanged item, to ensure transaction transparency.

Next, at step 612, the method may include the steps of sending real-time notifications to the buyer and seller regarding the status of the transaction and the availability of the item for pickup or drop-off. Further, the method may also include sending reminders to both the buyer and seller about deadlines for pickup or drop-off, ensuring timely completion of the transaction.

Thereafter, at step 614, the method may include the steps of integrating with third-party delivery services to offer home delivery as an optional service, upon buyer request, at an additional cost. Such integration may be performed with at least one third-party service selected from the group consisting of Uber™, DoorDash™, and similar delivery services. The method ends at step 616.

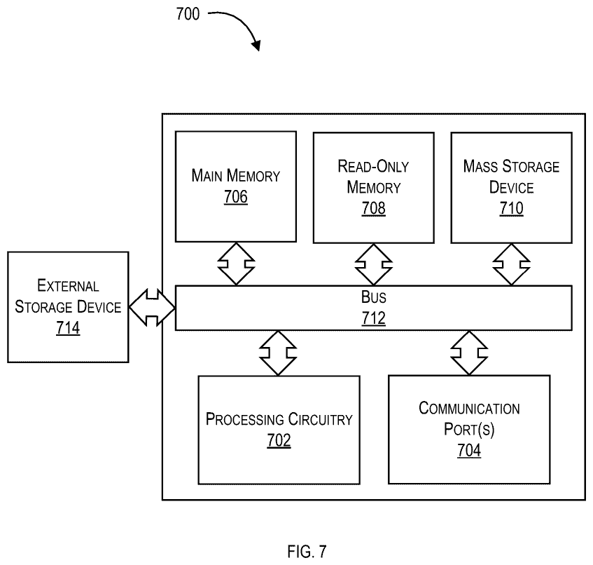

FIG. 7 is an exemplary computer unit 700 in which or with which embodiments of the present disclosure may be utilized. Depending upon the implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software and/or firmware. As shown in FIG. 7, the computer system 700 includes an external storage device 714, a bus 712, a main memory 706, a read-only memory 708, a mass storage device 710, a communication port(s) 704, and a processing circuitry 702.

Those skilled in the art will appreciate that the computer system 700 may include more than one processing circuitry 702 and one or more communication ports 704. The processing circuitry 702 should be understood to mean circuitry based on one or more microprocessors, microcontrollers, digital signal processors, programmable logic devices, Field-Programmable Gate Arrays (FPGAs), Application-Specific Integrated Circuits (ASICs), etc., and may include a multi-core processor (e.g., dual-core, quad-core, Hexa-core, or any suitable number of cores) or supercomputer. In some embodiments, the processing circuitry 702 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the processing circuitry 702 include, but are not limited to, an Intel® Itanium® or Itanium 2 processor(s), AMD® Opteron® or Athlon MP® processor(s), Motorola® lines of processors, System on Chip (SoC) processors, or other future processors. The processing circuitry 702 may include various modules associated with embodiments of the present disclosure.

The communication port 704 may include a cable modem, Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 704 may be any RS-232 port for use with a modem-based dialup connection, a 10/100 Ethernet port, a Gigabit, or a 10 Gigabit port using copper or fiber, a serial port, a parallel port, or other existing or future ports. The communication port 704 may be chosen depending on a network, such as a Local Area Network (LAN), Wide Area Network (WAN), or any network to which the computer system 700 may be connected.

The main memory 706 may include Random Access Memory (RAM) or any other dynamic storage device commonly known in the art. Read-only memory (ROM) 708 may be any static storage device(s), e.g., but not limited to, a Programmable Read-Only Memory (PROM) chips for storing static information, e.g., start-up or BIOS instructions for the processing circuitry 702.

The mass storage device 710 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 706. The mass storage device 710 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 712 communicatively couples the processing circuitry 702 with the other memory, storage, and communication blocks. The bus 712 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processing circuitry 702 to the software system.

Optionally, operator and administrative interfaces, e.g., a display, keyboard, and a cursor control device, may also be coupled to the bus 712 to support direct operator interaction with the computer system 700. Other operator and administrative interfaces may be provided through network connections connected through the communication port(s) 704. The external storage device 714 may be any kind of external hard drives, floppy drives, IOMEGA® Zip Drive, Compact Disc-Read-Only Memory (CD-ROM), Compact Disc-Re-Writable (CD-RW), Digital Video Disk Read Only Memory (DVD-ROM). The components described above are meant only to exemplify various possibilities. In no way should the aforementioned exemplary computer system limit the scope of the present disclosure.

The computer system 700 may be accessed through a user interface. The user interface application may be implemented using any suitable architecture. For example, it may be a stand-alone application wholly implemented on the computer system 700. The user interfaces application and/or any instructions for performing any of the embodiments discussed herein may be encoded on computer-readable media. Computer-readable media includes any media capable of storing data. In some embodiments, the user interface application is client-server-based. Data for use by a thick or thin client implemented on an electronic device computer system 700 is retrieved on-demand by issuing requests to a server remote to the computer system 700. For example, computer system 700 may receive inputs from the user via an input interface and transmit those inputs to the remote server for processing and generating the corresponding outputs. The generated output is then transmitted to the computer system 700 for presentation to the user.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. I claim all of the above subject matter.
